(19) United States
(12) Patent Application Publication
(10) Pub. No.: US 2011/0001099 A1
(43) Pub. Date: Jan. 6, 2011

(54) METHOD OF PULLING WIRE

(76) Inventors: Anthony SCUTARI, Warren, NJ (US); Frank VICENDESE, Warren, NJ (US)

Correspondence Address: Gearhart Law LLC, 41 River Road, Suite 1A, Summit, NJ, 07901, US

(21) Appl. No.: 12/826,865

(22) Filed: Jun. 30, 2010

Related U.S. Application Data
(60) Provisional application No. 61/222,870, filed on Jul. 2, 2009.

(51) Int. Cl. H02G 1/08

(52) U.S. Cl. 254/134.3 CL

(57) ABSTRACT

The present invention relates to a wire installation device having a clamp and at least one flexible loop disposed on the clamp. The claimed device may also have a feeder section between the clamp and the loop. The loop or loops are preferably thin, and are capable of substantially dispersing from one another to increase the likelihood of being snagged or caught by a user's hand or a standard fish line. The loop or loops are flexible and made out of a tear resistant material. A set screw, or other tightening means, positioned on the clamp, securely holds the wire or cable that is being installed or threaded. The entire embodiment is designed to be robust, compact and flexible, and ideal for use within spatially restricted or concealed areas, to minimize the effort entailed in dragging and installing wiring. The present invention is a very flexible, inexpensive device that can be easily utilized by consumers or by those who are professionally engaged in the art.

### CLAIM OF PRIORITY

This application claims the priority of U.S. Ser. No. 61/222,870 filed on Jul. 2, 2009, which is incorporated herein by reference.

### FIELD OF THE INVENTION

The invention relates to a device for use in dragging and installing concealed wiring or cabling in residential and commercial structures.

### BACKGROUND OF THE INVENTION

The invention relates to a unique and novel device that can be used to thread or drag a wire or cabling through cavities between beams and drywall or through conduits of various types. In the present state of the art, an assortment of means is being utilized for installing electrical conductors in conduits. The device most frequently employed in this pursuit is a metallic “fish tape” or “snake wire” which may be made from a flattened strip or spring steel material or may be formed of braided metal strands. In practice, such fish tapes or snake wires are pushed through a conduit preparatory to attaching either a guide line or an electrical conductor to the trailing end of the fish tape, after which the guide line or the electrical conductor is pulled through the conduit by means of the fish tape.

Existing methods and technologies are directed at conduit work and runway wiring, because these types of installations tend to have predictable, and often codified grading system of paths and turns that limit the ability of a dragged fish line or a wire to fold, crumple or tangle. However, these methods would not be easily suitable in drywall or ductless installations, where the wires have a far greater leeway of motion, thus presenting formidable challenges to the snagging and dragging technique of existing fish lines.

The present invention is more versatile than prior art devices since it is entirely suitable for wiring installation in conduits, and is also ideal for free space installations that do not have a controlled system of conduits, ducts or runways. Therefore the present invention is a substantial improvement over prior art since under current building practices, in many instances, having a conduit is no longer necessary or advisable; either because contemporary electrical or data cabling is already adequately insulated and shielded or because conduits add unnecessary limitations, prolong construction, and add superfluous costs to a project. A device is therefore needed that will function equally well in conduit and conduit-free installations, and unlike presently known devices, the claimed invention perfectly satisfies this requirement.

Additionally, the present invention provides a clamp that grasps the end section of a wire being pulled and does not require this section of the wire to be bent, twisted or otherwise deformed. This can be very desirable in cases where the wire is not very malleable and can be damaged if exposed to excessive twisting, such as with optical wires and other types of data cabling. The fact that the present invention does not damage the wire in any way, also provides an indirect benefit, in that once a segment of a wire reaches the desired terminus point, and is detached from the present invention, it does not require additional tools and labor to be clipped, cleaned or straightened, but rather can be immediately applied to the desired installation.

The relevant prior art involving fish wire for installing wiring includes: U.S. Pat. No. 7,201,364; U.S. Pat. No. 4,230,305; U.S. Pat. No. 4,171,123; and U.S. Pat. No. 3,858,848

### DESCRIPTION OF THE RELATED ART

U.S. Pat. No. 7,201,364 discloses an apparatus for pulling line through a raceway includes a plurality of linked mounts and at least one attachment member. The at least one attachment member is attached to an end of the plurality of linked mounts and is adapted to releasably attach to an end of a fish tape. Further, the plurality of linked mounts is repositionable relative to one another.

U.S. Pat. No. 4,230,305 discusses an electrical installation tool for use in electrical wire installations in areas of varying and unknown configuration comprising of a movable cable with a handle end and an adjustable fish wire end. The adjustable fish wire end is provided in the form of a bundle of flexible loops. Each of the flexible loops has an outer end that is secured to the cable fish wire end with the other end of each of the flexible loops being effectively held together at an intermediate point. The loops flare outwardly in a convex bundle, whereby the cable fish end can be moved back and forth. This movement has the effect of varying the distance between the cable fish wire end and the intermediate point, thereby to vary the flaring of the loop bundle to allow passage of the loop bundle or expansion or contraction of the loop bundle, as desired, in an area of varying or unknown configuration.

U.S. Pat. No. 4,171,123 teaches a conductor pulling device for pulling conductors through a conduit. A pulling member for independently receiving conductors consists of an elongated strip of material having a plurality of spaced openings therealong. The openings have a top portion which is larger than the bottom portion to provide a biting portion of each opening for biting into insulation disposed about a conductor when a portion of the conductor is inserted in one of the openings. The biting portion of the openings allows the conductors to be detachably retained to the strip while the conductors are pulled through a conduit. The elongated strip is connected to a fish tape by an aperture in the strip which receives a hook portion of the fish tape. Additionally, a hood made of organic polymeric material may be used to hold the conductors in place when the conductors are inserted through respective openings in the elongated strip and to reduce friction with the conduit. Still further, there is disclosed a method of pulling a plurality of conductors through a passage using the above-described conductor pulling device to individually and independently retain the individual conductors to respective openings while pulling the pulling member through a passage. More specifically, the method comprising the steps of inserting a portion of a conductor through one of the openings and urging that portion into engagement with the biting portion so that the biting portion of the opening bites into the insulation of the conductor to insure a positive grip, connecting the strip to a pulling means and pulling the pulling means thereby pulling the strip with the conductors attached thereto through a conduit.

U.S. Pat. No. 3,858,848 describes a The present invention provides a fish tape for drawing electric wires into conduits and the like The body of the fish tape comprises a unitary sheath or jacket of plastic, such as polyethylene, extruded onto a small diameter central core of fine stranded polyester fibers. The core has great strength in tension but lacks the necessary resistance to erosion, the necessary stiffness characteristics and resistance to external influences and stresses to constitute a fish tape. The sheath provides wear resisting and anti-friction qualities which the core of itself lacks, and provides along with the core a selected or predetermined degree of stiffness or controlled flexibility for threading the tape through a conduit. The means employed on one end—to apply tension for pulling the tape and attached conductor—is provided by an integral loop which in case of breakage or other injury is renewable. The loop is integral with one end of the tape. A means for renewably bonding a head or pulling eye to the front end of the composite body of the tape is provided by a small diameter coupling which has an eye at the forward end of the tape for hitching thereto the conductor to be pulled through the conduit. Both the connection of the pulling eye to the front end of the body of the tape and the connection of the loop to the rear end of the body of the tape are renewable with simple tools and simple manipulation. This makes possible a long useful life, not possessed to the same degree by any known non-metallic fish tape.

Various implements are known in the art, but fail to address all the problem solved by the invention described herein. One embodiment of this invention is illustrated in the accompanying drawings and will be described in more detail herein below.

### SUMMARY OF THE INVENTION

The present invention relates to a wire installation device having a clamp and at least one flexible loop disposed on the clamp. The claimed device may also have a feeder section between the clamp and the loop. The loop or loops are preferably thin, and are capable of substantially dispersing from one another to increase the likelihood of being snagged or caught by a user's hand or a standard fish line. The loop or loops are flexible and made out of a tear resistant material. A set screw, or other tightening means, positioned on the clamp, securely holds the wire or cable that is being installed or threaded. The entire embodiment is designed to be robust, compact and flexible, and ideal for use within spatially restricted or concealed areas, to minimize the effort entailed in dragging and installing wiring. The present invention is a very flexible, inexpensive device that can be easily utilized by consumers or by those who are professionally engaged in the art.

Therefore, the present invention succeeds in conferring the following, and other not mentioned, desirable and useful benefits and objectives.

It is an object of the present invention to provide a device to use in dragging and installing of electrical wiring and in other types of cabling or wiring.

It is another object of the present invention to provide for a reliable device that is simple and inexpensive to produce and market.

Yet another object of the present invention to provide a device that is capable of being utilized by amateur and professional installers.

Still another object of the present invention is to support wire installations with or without the presence of conduits, ducts, raceways or any other predictably controlled duct work.

Still another object of the present invention is to provide a device that can be fished out of a concealed space or can be used to snag and drag a separate fish line.

Yet another object of the present invention that is capable of dragging and installing a section of wiring without any damage to the wire.

Still another object of the present invention to provide a device whose length is adjustable.

### BRIEF DESCRIPTION OF THE DRAWINGS

FIG. 1 shows a close-up view of the preferred embodiment of present invention, demonstrating the flexibility of the invention and the preferred embodiment of a clamp.

FIG. 2 shows a top view of the preferred embodiment.

FIG. 3 shows a side view of the preferred embodiment.

FIG. 4 shows an instance of the preferred use of the present invention in the art.

FIG. 5 shows another instance of the preferred use of the present invention in the art.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

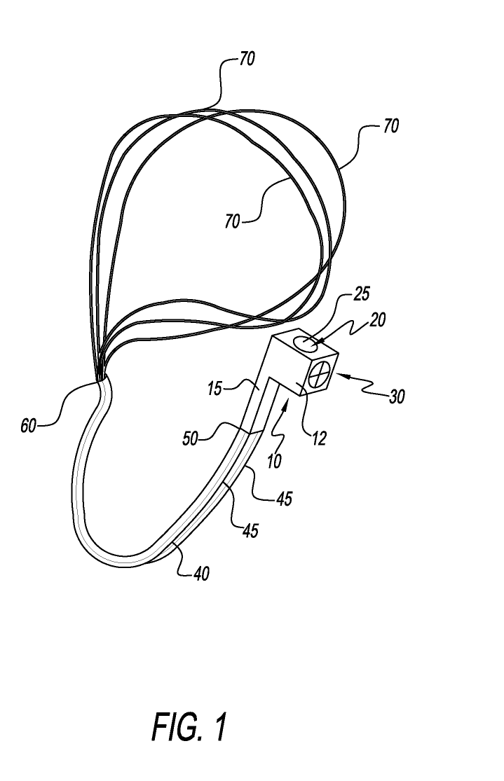

FIG. 1 discloses a coiled up rendering of the present invention. Shown are a clamp 10, a lower section 12, an upper section 15, a hollow channel 20, a hollow channel opening 25, a set screw 30, a feeder 40, a rigid member 45, a first end 50, a second end 60, and a plurality of flexible loops 70. The ideal length of the present invention is between 10 inches and 3 feet. The clamp 10 is disclosed in an L shaped embodiment, with the lower section 12 of the L accommodating a hollow channel 20 and a set screw 30; and with an upper section 15 connecting to the first end 50 of the feeder 40. Alternatively, the clamp 10 can be embodied in any shape that is commensurate with the use, such as, but not limited to, a substantially cylindrical or rectangular shape. The lower section 12 can be completely flush with the feeder 40 or upper section 15, rather then project laterally as shown.

The clamp 10 must be made of high tensile strength material as it must have the ability to tolerate multidirectional strains of various magnitudes during usage. The clamp 10 must also be shock absorbent and durable, since wiring and duct work tends to be highly abrasive and forceful. In the preferred embodiment shown in FIG. 1, the clamp 10 is made of metal, since this is the strongest and least expensive material available. However, the clamp 10 may also be produced from a strong composite material, such as high density thermoplastic or polyvinyl chloride, as well as from a metallic alloy, fortified rubber, ceramics or wood.

The hollow channel 20 may be substantially elliptical, concave or more substantially square. The hollow channel 20 may have a hollow channel opening 25 on both ends of the lower section 12, to permit a wire to pass-through completely (not shown), or have a hollow channel opening 25 on one end only as shown. The diameter of the hollow channel opening should preferably be between 0.5″ and 2″, and the overall length of the hollow channel 20 should be preferably between 0.5″ and 4″. The overall diameter of the clamp 10 can be less then ½ of an inch and as large as 4″.

The feeder 40 is shown in FIG. 1 having a first end 50, a second end 60, and several rigid members 45. The first end 50 connects to the upper section 15 of the clamp 10, whereas the second end 60 accommodates a plurality of loops 70. The connection among the components of the present invention needs to be very robust and be able to withstand substantial thrusting and heaving forces. Various alternative methods of joining the components of the present invention may be used, including, but not limited to, riveting, crimping, welding, soldering, brazing, taping, gluing, cementing, or through the use of various adhesives. It may be desirous to assemble and disassemble the present invention at will or at a work site, or to interchange components, such as to add a longer, shorter, wider or narrower feeder 40, a different clamp 10 or loops 70. In such a case, a more temporary coupling means is preferred, such as, but not limited to, male/female fasteners using threaded or frictional coupling elements.

The presence of the feeder 40 is not required for the enablement of this invention. In its absence, the loops 70 would emanate directly out of the clamp 10. The preferable dimensions of the feeder 40 are between 6 and 12 inches in length, and between 125″ and 1″ in width. In a cylindrical embodiment of the feeder 40, the cross sectional diameter should be preferably between 0.125″ and 1″. In FIG. 1 the feeder 40 is shown having several rigid members 45. The presence of at least one rigid member 45 is not preferred, but is highly desired, as it bolsters the structural integrity and the overall strength and stress tolerance of the claimed device. The rigid member 45 helps the device resist twists and entanglements, and additionally, provides a broader coupling surface with other components. In FIG. 1, the embodiment of the rigid element 45 is in form of two ribbed lines running the length of the feeder 40. However, fewer, none at all, or additional rigid elements 45 may be used in a variety of traversal or longitudinal embodiments. The feeder 40 can be made out of any durable and flexible material, such as, but not limited to, rubber, plastic, nylon, steel, or any composite or reinforced material, as well as out of metallic or plastic wiring. In a more rudimentary construction of the present invention (not shown), the feeder 40 would be a section of tubing disposed around a section of a wire, with this wiring connecting to the clamp 10 at first end 50 and emerging as the embodied flexible loops 70 out of the second end 60.

Still referring to FIG. 1, the present invention is enabled with at least one flexible loop 70. However, an embodiment having three, four or a plurality flexible loops 70 is preferred. In a concealed space, a greater number of flexible loops 70 makes it easier to snag the present invention with a hook or a fish line, as will be shown in the later figures. The diameter of the flexible loops 70 is preferably between 3 and 18 inches and should preferably be made of any type of wiring or filament. However, any other flexible, strong or fibrous material may also be used. In an embodiment having two or more flexible loops 70, each flexible loop 70 may be of the same or different diameters. Any flexible loop 70 in any given embodiment of the present invention may be made of a different material than any other flexible loop 70 in the same embodiment. Each flexible loop 70 can be made from one or several strands of wiring, filament or other material. The preferred cross-sectional diameter of a strand forming each flexible loop 70 should be preferably between 0.125″ and 0.5″.

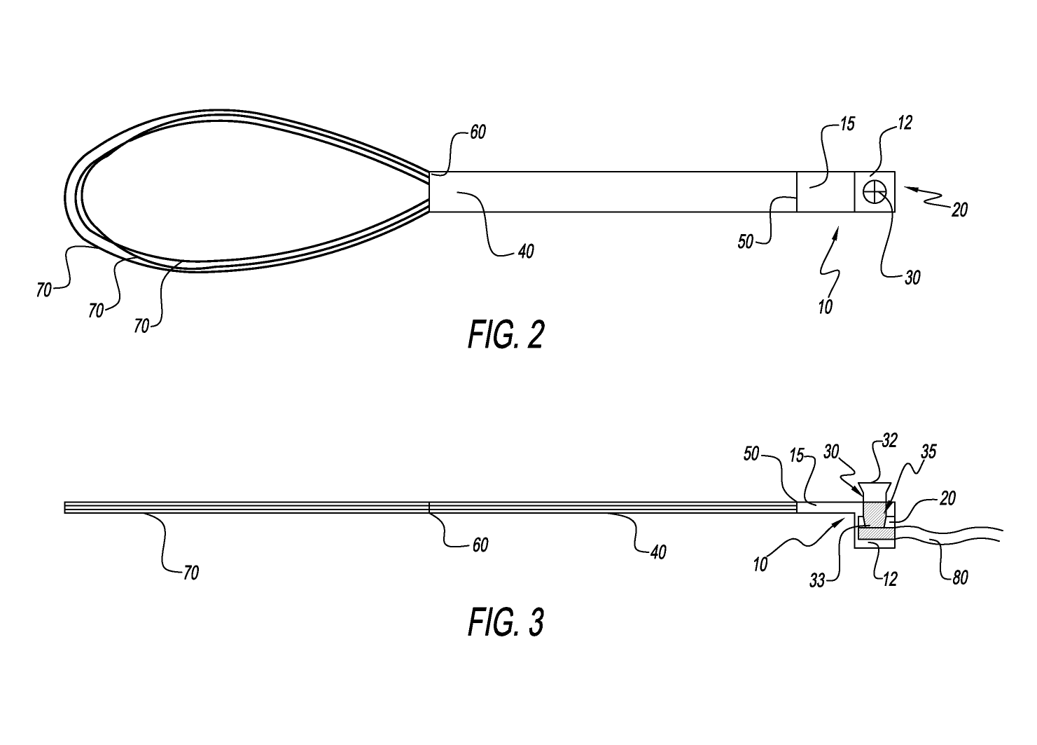

FIG. 2 is a top view of the present invention, while FIG. 3 is a side view of the present invention. Looking at these figures, one skilled in the art can appreciate the apparent novelty and utility of the flexible loops 70, and further appreciate that the dimensions of the overall invention make the present invention perfectly suitable for installations involving concealed wiring or cabling. Shown in FIGS. 2 and 3 are a clamp 10, a lower section 12, an upper section 15, a set screw 30, a feeder 40, a first end 50, a second end 60, and flexible loops 70. Additionally, FIG. 3 also shows a hollow channel 20, a set screw head 32, a set screw end 33, a set screw opening 35, and a wire 80. The set screw 30 can be frictionally or threadedly disposed within the set screw opening 35. As shown in the cross sectional diagram in FIG. 3, the wire 80 is received within the hollow channel 20 and then pinned into place with a set crew 30. The depth or pressure of the set screw 30 can be varied by adjusting the set screw head 32 with a screw driver, pliers or by hand. The set screw head 32 is shown as Phillips screw head embodiment but may be in any shape or form, such as, but not limited to, flat head, octagonal, square or torx. Alternatively the set screw head 32 may have wing nut embodiment for optimal tightening by hand. The set screw 30 may terminate in a pointed or in a flat bolt-like bottom end 33. One alternative (not shown) to the diagramed embodiment is be to make the clamp 10, or just its lower section 12, of two disconnected parts, with the wire or cable tightly held between these two parts. One or more fasteners, or one or more O-clamps, or any other tightening means used in the art to tighten tubular structures, would maintain a tight bind over sections and the secured wire in this embodiment. Another alternative (not shown) is to have the lower section 12 be entirely connected on one end and form a cleavage on the other end, with the wire or cable inserted into the hollow space formed by the cleavage. A set screw, fasteners or O-clamps could then be used to tighten such and embodiment and the inserted wire or cable.

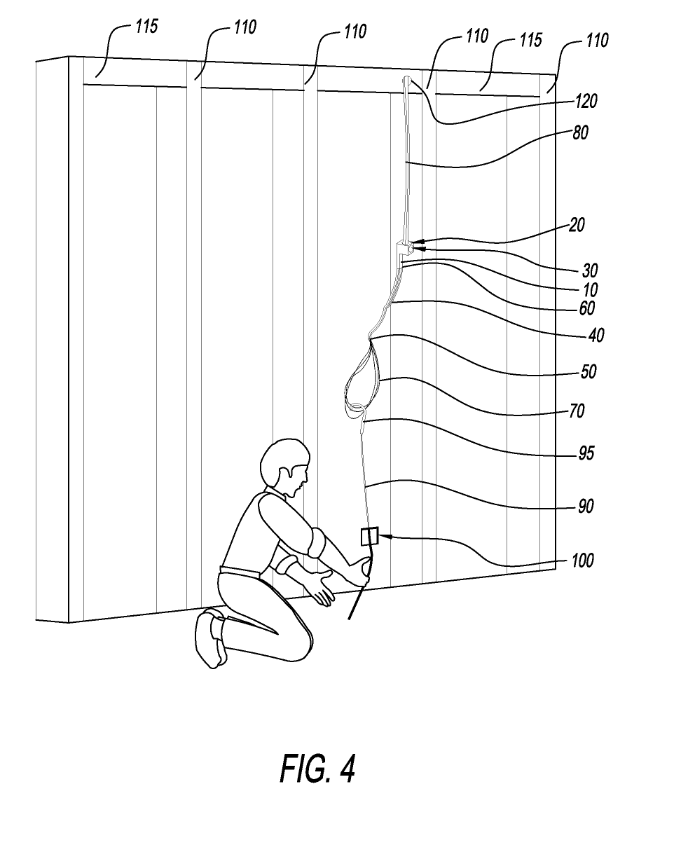

Shown in FIG. 4 are a clamp 10, a hollow channel 20, a set screw 30, a feeder 40, a first end 50, a second end 60, several flexible loops 70, a wire 80, a fish line 90, a fish line hook 95, a wall opening 100, a stud 110, a top beam 115, a drill hole 120, and a stud cover 130. In this figure the present invention is suspended between studs 110 and concealed by a stud cover 130, more commonly known as drywall, sheetrock or paneling. Prior to the step shown in FIG. 4, the wire 80 that is shown attached to the clamp 10, is suspended from a top beam 115 or dragged from another location by using the present invention. The primary method of accomplishing this initial step is to attach the wire or cable to the clamp 10 and then to thread it into the wall through the wall opening 110 or to drop it down from the top beam 115. In either even, the flexible loops 70 would always lead and precede the rest of the device and the wire being dragged or installed.

FIG. 4 shows the user utilizing a fish line 90, which can also be any substantially hooked device that has been previously threaded into the wall opening 100. The user determines whether the hook 95 of the fish line 90 has come abreast with the flexible loops 70 either by estimating the distance based on the length of the fish line 90 that is already concealed within the stud cover 130, or if further threading is met with any degree of vibration or resistance. At this point, the user would drag the fish line 90 into the opposite direction from the direction of threading, causing the hook 95 to snag one or all of the flexible loops 70. One skilled in the art will be able to appreciate that the flexible loops 70 tend to disperse within the cavity that is formed between studs 110 and stud cover 130, thus increasing the likelihood of being quickly detected and snagged by the fish line hook 95, and thereby decreasing typical installation times by eliminating the need for repeated attempts. One skilled in the art will further appreciate that while the invention is ideal for use within the diagramed environment, it may also be used to within a runway, duct or a conduit. Additionally, the flexible loops 70 can be made to form a pattern, such as a fan pattern, interlocking ring pattern, or forming a pattern of unfurled petals around the clamp 10, or the feeder 40, if one is present, or any other pattern that will increase the degree of dispersion and density of coverage afforded by the flexible loops 70.

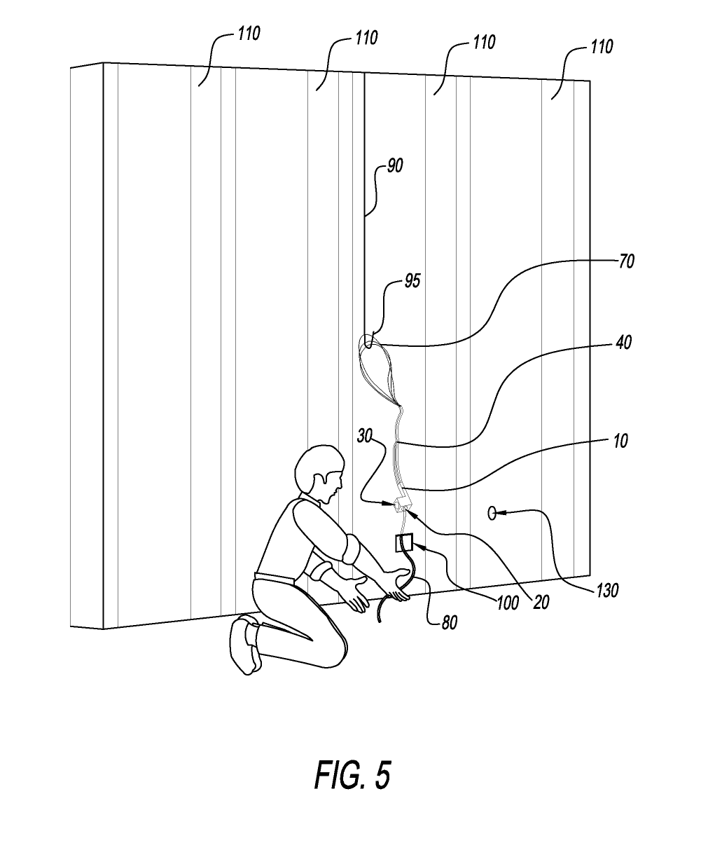

The present invention is equally suitable for threading a wire into the wall opening 100, either in a downward (FIG. 4) or an upward direction as shown in FIG. 5. When threading in an upward direction, the feeder 40 with an optional rigid element 45, if present, supplies additional lateral strength that works to prevent folding, crunching-up, or crumpling, as the device is prodded upward, or against the force of gravity and any other unseen obstacle.

FIG. 5 shows a clamp 10, a hollow channel 20, a set screw 30, a feeder 40, several flexible loops 70, a wire 80, a wall opening 100, studs 110, and a stud cover 130. The user in this diagram is inserting the wire into the wall opening 100. Before initiating the process of insertion, the user (shown kneeling) secures the wire or cable 80 within the hollow channel 20. The present invention is then inserted into the wall opening 100, with the flexible loops 70 in the lead. At this point, the user can either continue to propel the present invention upward by thrusting the wire from below or by pulling it from the top after first catching the loops 70 with a fish line hook 95 at the end of the fish line 90, shown suspended between two studs 110.

The present invention can be used to augment a standard fish line wire installation. In such cases a wire may be dragged using a standard fish line 90 (FIG. 4) having a snagable element, such as a hook 95 (FIG. 4). Once the hook 95 comes within a substantially close proximity relative to an access point for the present invention, such as the wall opening 100, the present invention may be inserted and threaded toward the hook 95 of the fish line 90, with the intent of catching the hook 95 with the loops 70. As soon as the hook 95 is captured with the present invention, the present invention is pulled back toward an opening, eventually dragging out the captured fish line 90, with the attached wire 80.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. An article of manufacture, comprising:
a clamp; and
at least one flexible loop disposed on the clamp.

2. The article of claim 1, wherein the claim and flexible loop are separated by a feeder.

3. The article of claim 1, wherein the clamp has a plurality of flexible loops.

4. The article of claim 1, wherein the clamp has four flexible loops.

5. The article of claim 1, wherein the clamp is a hollow channel with a set screw.

6. The article of claim 1, wherein the at least one flexible loop is made of filament.

7. The article of claim 1, wherein the at least one flexible loop is made of wire.

8. The article of claim 3, wherein the flexible loops are made of filament.

9. The article of claim 3, wherein the flexible loops are made of wire.

10. The article of claim 1, wherein the at least one flexible loop has a diameter of from 3 to 18 inches.

11. The article of claim 3, wherein the flexible loops have differing diameters.

12. The article of claim 3, wherein the flexible loops spread in a pattern.

13. The article of claim 1, wherein the clamp has a diameter of less than ½ inch.

14. The article of claim 1, wherein the clamp is made of aluminum.

15. The article of claim 2, wherein the length of the feeder is from 6 to 12 inches.

16. The article of claim 1, wherein the feeder is made of plastic.

17. The article of claim 1, wherein the feeder further comprises at least one rigid member.
